(19) United States
(12) Patent Application Publication
(10) Pub. No.: US 2005/0095182 A1
(43) Pub. Date: May 5, 2005

(54) Electro-kinetic air transporter-conditioner devices with electrically conductive foam emitter electrode

(75) Inventor: Jimmy L. Lee, Rohnert Park, CA (US)

Correspondence Address: FLIESLER MEYER, LLP, FOUR EMBARCADERO CENTER, SUITE 400, SAN FRANCISCO, CA, 94111, US

(73) Assignee: Sharper Image Corporation, San Francisco, CA (US)

(21) Appl. No.: 10/944,016

(22) Filed: Sep. 17, 2004

Related U.S. Application Data
(60) Provisional application No. 60/504,582, filed on Sep. 19, 2003.

(51) Int. Cl. B01J 19/08

(52) U.S. Cl. 422/186.04

(57) ABSTRACT

An electro-kinetic air conditioner includes an ion generator that has an electrode assembly including a first array of emitter electrode(s), a second array of collector electrode(s), and a high voltage generator. The first and/or second electrode array can be include an electrically conductive foam, which may provide various advantages.

### PRIORITY CLAIM

This application claims priority to under 35 U.S.C. § 119(e) to U.S. Provisional Patent Application No. 60/504,582, entitled “Electro-Kinetic Air Transporter-Conditioner Devices with Electrically Conductive Foam Emitter Electrode,” filed Sep. 19, 2003.

### CROSS-REFERENCE TO RELATED ART

The present invention is related to the following patent and application, which are incorporated herein by reference: U.S. Pat. No. 6,176,977, entitled “Electro-Kinetic Air Transporter-Conditioner; and U.S. patent application Ser. No. 10/074,827 (Attorney Docket No. SHPR-01041USQ), filed Feb. 12, 2002, entitled “Electro-Kinetic Air Transporter-Conditioner with Non-Equidistant Collector Electrodes.”

### FIELD OF THE INVENTION

The present invention relates generally to ion generating devices that produce an electro-kinetic flow of air from which particulate matter is substantially removed.

### BACKGROUND OF THE INVENTION

The use of an electric motor to rotate a fan blade to create an airflow has long been known in the art. Unfortunately, such fans produce substantial noise, and can present a hazard to children who may be tempted to poke a finger or a pencil into the moving fan blade. Although such fans can produce substantial airflow (e.g., 1,000 ft³/minute or more), substantial electrical power is required to operate the motor, and essentially no conditioning of the flowing air occurs.

It is known to provide such fans with a HEPA-compliant filter element to remove particulate matter larger than perhaps 0.3 μm. Unfortunately, the resistance to airflow presented by the filter element may require doubling the electric motor size to maintain a desired level of airflow. Further, HEPA-compliant filter elements are expensive, and can represent a substantial portion of the sale price of a HEPA-compliant filter-fan unit. While such filter-fan units can condition the air by removing large particles, particulate matter small enough to pass through the filter element is not removed, including bacteria, for example.

It is also known in the art to produce an airflow using electro-kinetic techniques, by which electrical power is converted into a flow of air without mechanically moving components. One such system is described in U.S. Pat. No. 4,789,801 to Lee (1988), depicted herein in simplified form as FIGS. 1A and 1B and which patent is incorporated herein by reference. System 10 includes an array of first (“emitter”) electrodes or conductive surfaces 20 that are spaced-apart symmetrically from an array of second (“collector”) electrodes or conductive surfaces 30. The positive terminal of a pulse generator 40 that outputs a train of high voltage pulses (e.g., 0 to perhaps +5 KV) is coupled to the emitter array, and the negative pulse generator terminal is coupled to the collector array in this example. It is to be understood that the arrays depicted include multiple electrodes, but that an array can be a single electrode.

The high voltage pulses ionize the air between the arrays, and create an airflow 50 from the emitter array toward the collector array, without requiring any moving parts. Particulate matter 60 in the air is entrained within the airflow 50 and also moves towards the collector electrodes 30. Much of the particulate matter is electrostatically attracted to the surfaces of the collector electrodes, where it remains, thus conditioning the flow of air exiting system 10. Further, the high voltage field present between the electrode arrays can release ozone into the ambient environment, which can eliminate odors that are entrained in the airflow.

In the particular embodiment of FIG. 1A, the emitter electrodes 20 are circular in cross-section, having a diameter of about 0.003″ (0.08 mm), whereas the collector electrodes 30 are substantially larger in area and define a “teardrop” shape in cross-section. The ratio of cross-sectional radii of curvature between the bulbous front nose of the second electrode and the first electrodes exceeds 10:1. As shown in FIG. 1A, the bulbous front surfaces of the second electrodes face the first electrodes, and the somewhat “sharp” trailing edges face the exit direction of the airflow. The “sharp” trailing edges on the second electrodes supposedly promote good electrostatic attachment of particulate matter entrained in the airflow.

In another prior art embodiment shown herein as FIG. 1B, the collector electrodes 30 are symmetrical and elongated in cross-section. The elongated trailing edges on the collector electrodes provide increased area upon which particulate matter entrained in the airflow can attach.

Particulate matter collects on the array of collector electrodes, which can be wiped cleaned by a user. After extended use, particulate matter in the form of a deposited layer or coating of fine ash-like material also collects on the wire or wire-like emitter electrodes in the first array, which are much less robust and more fragile than the collector electrodes. (The terms “wire” and “wire like” shall be used interchangeably herein to mean an electrode either made from wire or, if thicker and stiffer than wire, having an appearance of wire.) Thus, care is required during cleaning of the first array of electrodes to prevent excessive force from simply snapping the wire like electrodes. Further, even with care there is always the potential that the wire electrodes will snap. Thus, it would be advantageous produce an array of emitter electrodes that is less delicate and thus easier to clean, that has equivalent or increased ion and/or air transport efficiency.

Other prior electro-kinetic precipitator type devices (not shown) have used electrodes other than wires as the emitting or discharge type electrodes. For example, one or more pin or needle shaped electrodes have been used as the emitter electrodes. For another example, plates having a razor-like edge, a sawtooth type edge, or a plurality of pins extending from an edge, have been used as emitting electrodes. Barbed wire like emitters have also been used.

All of the just described emitter electrodes include sharp edges or points because it has been believed that sharp points or edges were necessary to create a discharge current that sufficiently charges particles in the vicinity of the emitter electrode(s) to electrostatically move the charge particles toward the generally plate like collector electrodes. As with the wire like emitter electrodes discussed above, a fine ash-like material collects on these sharp emitter electrodes, reducing their effectiveness. As with the wire like emitter electrodes, some of the sharp emitter electrodes, such as ones including needles, may be fragile, and thus, difficult to clean. Thus, it would be advantageous to produce an emitter array of electrodes that in addition to being less fragile, is easy to clean.

### SUMMARY OF THE INVENTION

In accordance with an embodiment of the present invention, an electro-kinetic air conditioner includes a first array of at least one emitter electrode, a second array of at least one collector electrode, and a high voltage generator, wherein the array of emitter electrodes includes an electrically conductive foam.

The inclusion of an electrically conductive foam in the emitter electrodes promotes higher ionization. This is because the electrically conductive foam has more ion emitting surfaces than other designs. The electrically conductive foam is preferably sufficiently robust to withstand cleaning, has a high melting point to retard breakdown due to ionization, and has a rough exterior surface to promote efficient ionization.

The use of a conductive foam as the emitter electrode(s) allows for easier and safer cleaning. Such a foam can be supported by a support structure, e.g., a metal support structure, that will add strength to the foam emitter electrode.

In accordance with an embodiment of the present invention, the electrically conductive foam electrode(s) can be removed from the housing by a user, and is less likely to be broken than other potential emitter electrodes that may be used in an ion generating electro-kinetic system. The electrically conductive foam electrode(s) should also be safer to clean than emitter electrodes that rely on sharp points or edges for ionization.

In accordance with an embodiment of the present invention, the electrically conductive foam is or includes a carbon foam. The carbon foam, can be, for example, an open cell glass carbon foam. The electrically conductive foam can be or include, for example, a silicon carbide, a cross-linked polyethylene, a carbon-loaded polyolefin plastic, and/or a metal plated open-cell foam.

In accordance with another embodiment of the present invention, an electrically conductive carbon foam is located downstream or near the downstream ends of the collector electrodes to neutralize any excess positive ions.

Other objects, aspects, features and advantages of the invention will appear from the following description in which the preferred embodiments have been set forth in detail, in conjunction with the accompanying drawings and also from the following claim.

### BRIEF DESCRIPTION OF THE DRAWINGS

FIGS. 1A-1B; FIG. 1A is a plan, cross-sectional view, of a first embodiment of an electro-kinetic air transporter-conditioner system according to the prior art; FIG. 1B is a plan, cross-sectional view, of a second embodiment of an electro-kinetic air transporter-conditioner system according to the prior art.

FIGS. 2A-2D; FIG. 2A is a perspective view of a housing of an electro-kinetic air transporter-conditioner, according to an embodiment of the present invention; FIG. 2B is a perspective view of the embodiment shown in FIG. 2A illustrating the removable first and second electrodes; FIG. 2C is a perspective view of an embodiment where the first and second electrodes are separately removable. FIG. 2D is a perspective view of a housing of an electro-kinetic air transporter-conditioner unit, according to a further embodiment of the present invention.

FIG. 3 is an exemplary electrical block diagram, that can be used with embodiments of the present invention.

FIGS. 4A-4E; FIG. 4A is a perspective view showing an embodiment of an electrode assembly according to an embodiment of the present invention; FIG. 4B is a plan view of the embodiment illustrated in FIG. 4A; FIG. 4C is a perspective view showing another embodiment of an electrode assembly according to the present invention; FIG. 4D is a plan view of the embodiment of FIG. 4C; FIG. 4E is a perspective view showing yet another embodiment of an electrode assembly according to the present invention.

FIGS. 5A-5B; FIG. 5A is a plan view of another embodiment of the present invention; FIG. 5B is a perspective view of the embodiment shown in FIG. 5A.

FIGS. 6A-6B; FIG. 6A is a plan view of a further embodiment of the present invention; FIG. 6B is a perspective view of the embodiment shown in FIG. 6A.

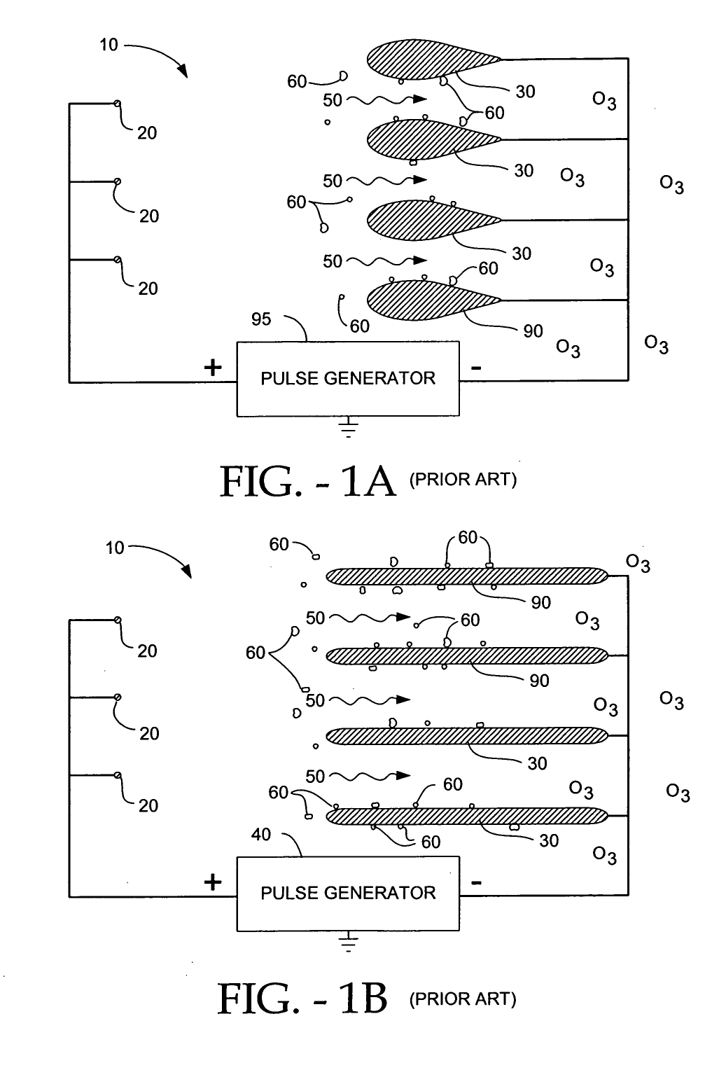

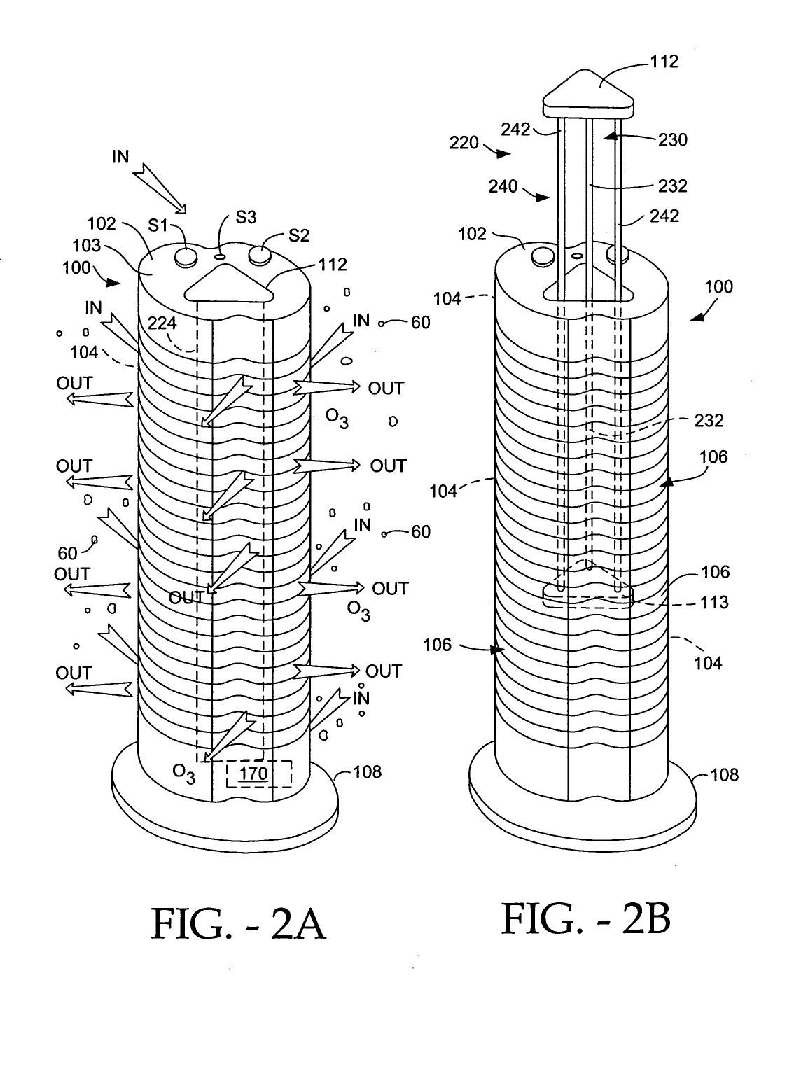

### DETAILED DESCRIPTION OF THE PREFERRED EMBODIMENT

Overall Air Transporter-Conditioner System Configuration:

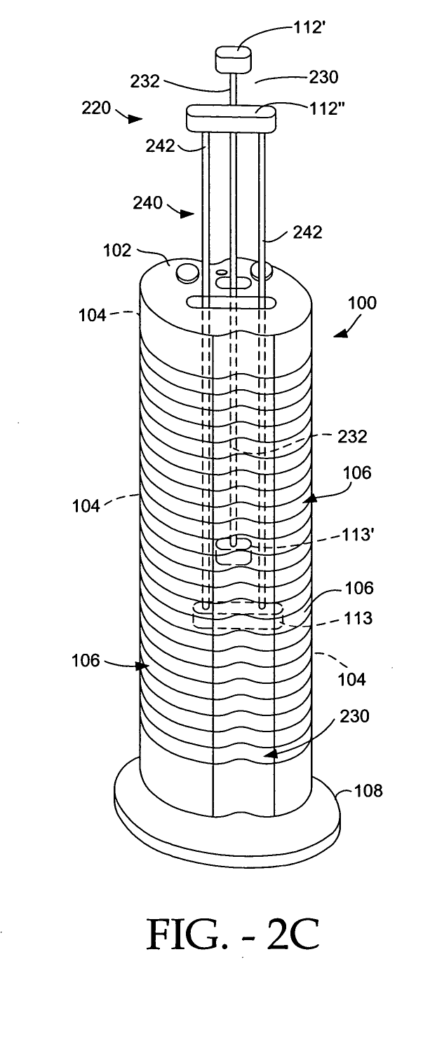

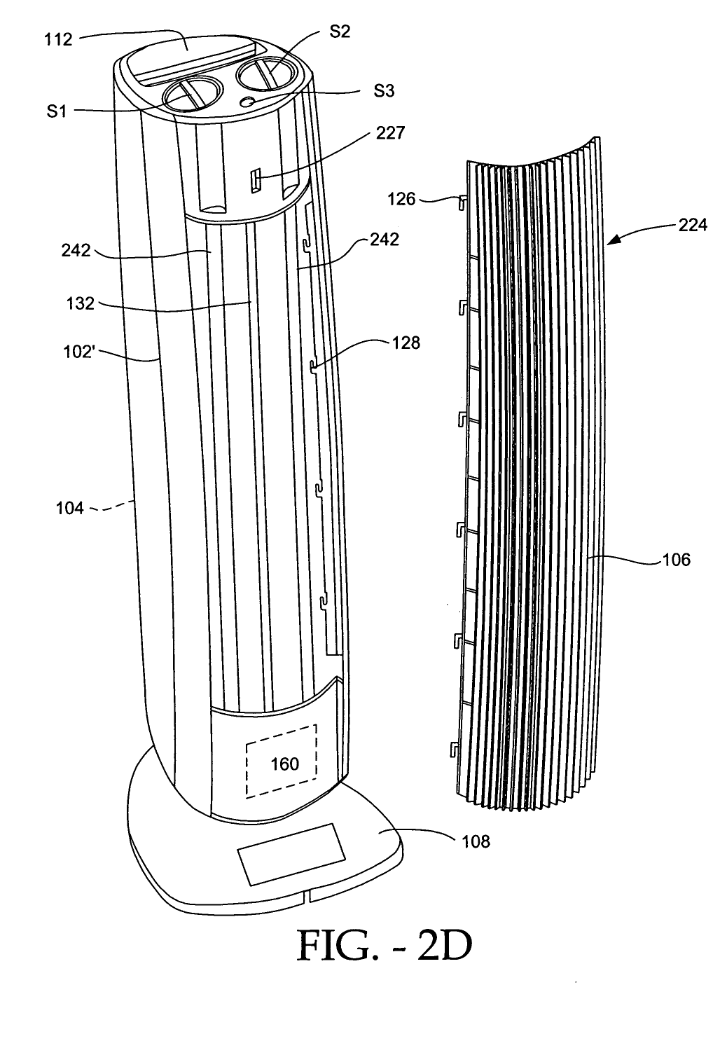

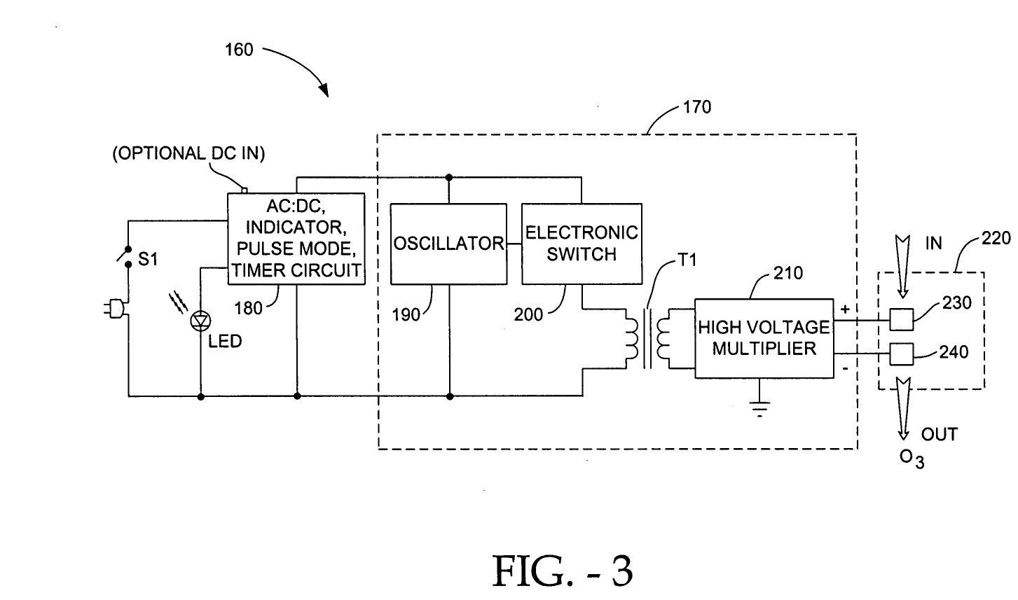

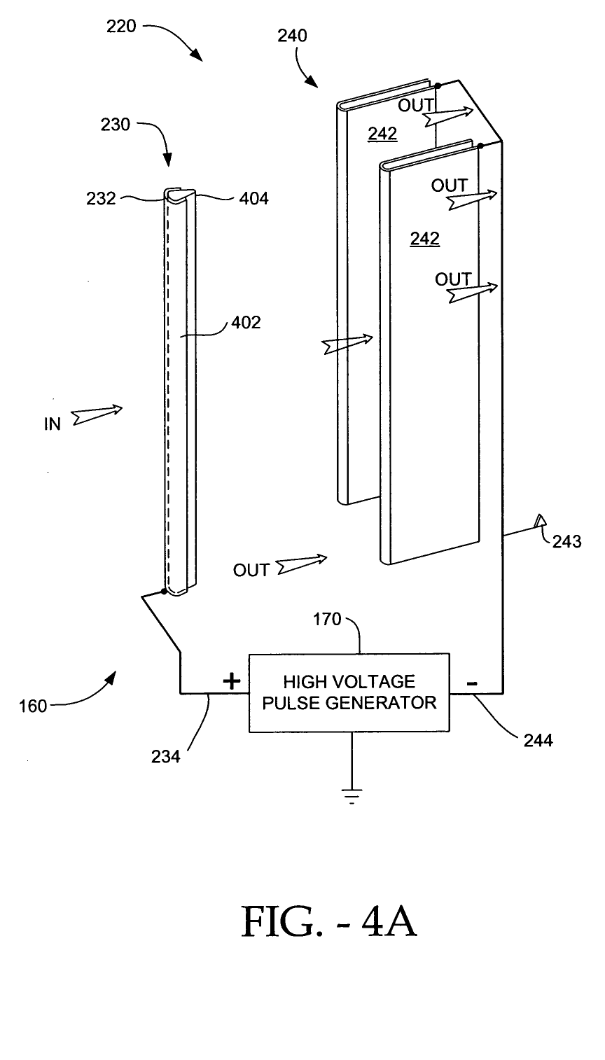

FIGS. 2A and 2B depict an electro-kinetic air transporter-conditioner system 100 whose housing 102 includes preferably rear-located intake vents or louvers 104 and preferably front located exhaust vents 106, and a base pedestal 108. If desired, a single vent can provide and be used as both an air intake and an air exhaust with an air inlet channel and an air exhaust channel communicating with the vent and the electrodes. Preferably the housing is freestanding and/or upstandingly vertical and/or elongated. Internal to the transporter housing 102 is an ion generating unit including a high voltage generator 170, preferably powered by an AC:DC power supply that is energizable or excitable using switch S1. The switch S1 and other user operated switches can be conveniently located at the top 103 of the unit 100. The electro-kinetic air transporter-conditioner system 100 is self-contained in that other than ambient air, nothing is required from beyond the transporter housing, save external operating potential, for operation of the present invention.

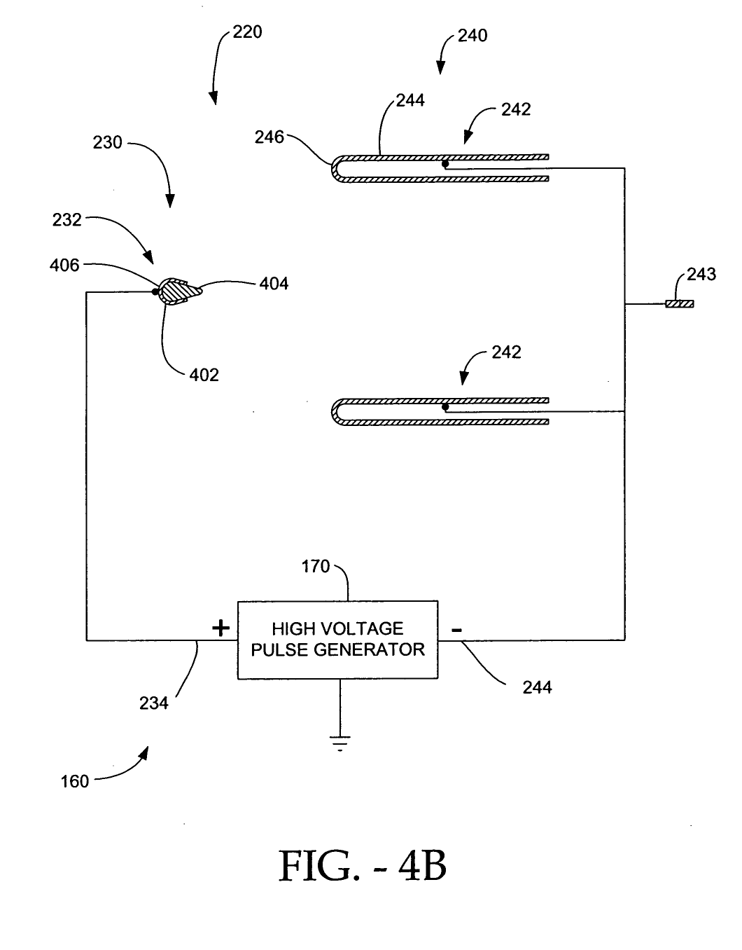

Accessible through the upper or top surface 103 of the housing 102 is a user-liftable handle member 112, which is used to remove an electrode assembly 220 from the housing 102, for the purpose of cleaning the assembly. In this embodiment, the electrode assembly 220 includes a first array 230 of emitter electrodes 232 and a second array 240 of collector electrodes 242. In the embodiment shown, the lifting member 112 lifts both the first array electrodes 230 and the second array electrodes 240 upward, causing the electrodes to telescope out of the top 103 of the housing 102 and, if desired, out of unit 100 for cleaning. As is evident from FIG. 2B, the electrodes can be lifted vertically out from the top 103 of unit 100 along the longitudinal axis or direction of the elongated housing 102. This arrangement makes it easy for the user to pull the electrodes out for cleaning. As also shown in FIG. 2B, the bottom ends of the electrodes can be connected to a member 113. The first and second arrays of electrodes are coupled to the output terminals of the high voltage generator, as best seen in FIG. 3, discussed below.

In another embodiment, shown in FIG. 2C, the first array 230 and second array 240 are each separately removable from housing 102. In this embodiment, a first user-liftable handle member 112′ is used to remove the first array 230, and a second user-liftable handle member 112″ is used to remove the second array 240 from the housing 102, for the purpose of cleaning the electrodes. As shown in FIG. 2C, the bottom end of electrode 232 is connected to a member 113′, and the bottom ends of electrodes 242 are connected to a member 113″. This embodiment is useful because second array 240 may require cleaning more often than first array 230. Using this embodiment, the first array electrodes 230 can remain in the housing 102 while the second array 240 are removed for cleaning, and vice versa.

In each of the embodiments where an array of electrodes is removable, there is likely one or more contact terminals within the housing that will provide a conductive path from a terminal of the high voltage generator 170 to an appropriate array, when that array is in its resting position within the housing. When the array is lifted (e.g., using a user-liftable handle), the array and the contact terminal will disengage from one another. This will ensure that an array lifted from the housing is no longer providing a high voltage potential. If the liftable array is intended to be grounded in accordance with an embodiment of the present invention, the corresponding contact terminal within the housing for that array should be grounded.

In the exemplary embodiments shown in FIGS. 2A, 2B and 2C, the first array 230 is shown as including a single electrode 232, and the second array 240 is shown as including two electrodes 242. However, the first array 230 can include more than one electrode 232, and the second array 240 can include a single electrode 323, (but likely two or more electrodes 234) as will be shown in many of the remaining figures discussed below.

The general shape of the embodiments shown in FIGS. 2A-2C can be that of a figure eight in cross-section, although other shapes are within the spirit and scope of the invention. The top-to-bottom height in can be, for example, about 1 m, with a left-to-right width of about 15 cm, and a front-to-back depth of perhaps 10 cm, although other dimensions and shapes can of course be used. A louvered construction provides ample inlet and outlet venting in an economical housing configuration. There need be no real distinction between vents 104 and 106, except their location relative to the second electrodes. These vents serve to ensure that an adequate flow of ambient air can be drawn into or made available to the unit 100, and that an adequate flow of ionized air flows out from unit 100.

As will be described, when unit 100 is energized using S1, high voltage or high potential output by ion generator 160 produces ions at the first electrode(s), which ions are attracted to the second electrodes. The movement of the ions in an “IN” to “OUT” direction carries with the ions air molecules, thus electro-kinetically producing an outflow of ionized air. The “IN” notation in FIGS. 2A-2C denote the intake of ambient air with particulate matter 60. The “OUT” notation in the figures denotes the outflow of cleaned air substantially devoid of the particulate matter, which particulates matter adheres electrostatically to the surface of the second electrodes. In the process of generating the ionized airflow appropriate amounts of ozone (O₃) are beneficially produced. It may be desired to provide the inner surface of housing 102 with an electrostatic shield to reduces detectable electromagnetic radiation. For example, a metal shield could be disposed within the housing, or portions of the interior of the housing can be coated with a metallic paint to reduce such radiation.

The housing may have a substantially oval-shaped or-elliptically shaped cross-section with dimpled side grooves. Thus, as indicated above, the cross-section looks somewhat like a figure eight. It is within the scope of the present invention for the housing to have a different shaped cross-section such as, but not limited to, a rectangular shape, an egg shape, a tear-drop shape, or circular shape. The housing preferably has a tall, thin configuration. As will become apparent later, the housing is preferably functionally shaped to contain the electrode assembly.

As mentioned above, the housing has an inlet and an outlet. Both the inlet and the outlet may be covered by fins or louvers. Each fin is a thin ridge spaced-apart from the next fin, so that each fin creates minimal resistance as air flows through the housing. The fins are, for example, horizontal and are directed across the elongated vertical upstanding housing of the unit. Thus, the fins are substantially perpendicular in this preferred embodiment to the electrodes. The inlet and outlet fins are aligned to give the unit a “see through” appearance. Thus, a user can “see through” the unit from the inlet to the outlet. The user will see no moving parts within the housing, but just a quiet unit that cleans the air passing therethrough. Alternatively the fins can be parallel with the electrodes in another preferred embodiment. Other orientations of fins and electrodes are possible in other embodiments.

FIG. 2D illustrates an electro-kinetic air transporter-conditioner system 100 having an alternative housing 102′. In this embodiment, housing 102′ has a removable front panel 124, allowing a user to access and clean the electrodes without removing the electrodes from the housing. This front panel 124 in this embodiment defines the air inlet and includes the vertical louvers. The front panel 124 has locking tabs 126 located on each side, along the entire length of the panel 124. In accordance with an embodiment of the invention, the locking tabs 226, as shown in FIG. 3E, are “L″-shaped. Each tab 124 extends away from the panel 124, inward towards the housing 102′, and then projects downward, parallel with the edge of the panel 124. It is within the spirit and scope of the invention to have differently shaped tabs 126. Each tab 124 individually and slidably interlocks with recesses 128 formed within the housing 102. The front panel 124 also has a biased lever (not shown) located at the bottom of the panel 124 that interlocks with the recess 130. To remove the panel 124 from the housing 102, the lever is urged away from the housing 102, and the panel 124 is slid vertically upward until the tabs 126 disengage the recesses 128. The panel 124 is then pulled away from the housing 110. Removing the panel 124 exposes the electrodes for cleaning. A similar removable panel can be located on the other side of the housing (i.e., the back side not seen in FIG. 2D) so that both the first electrode array 230 and the second electrode array 240 are easily accessible for cleaning. If desired, this housing 102 may also include a handle 112 to remove one or more of the electrodes. As with the previously described embodiments, the housing 102′ can include rear-located intake vents or louvers 104 and front located exhaust vents 106, and a base pedestal 108. If desired a single vent can provide and be used as both an air intake and an air exhaust with an air inlet channel and an air exhaust channel communicating with the vent and the electrodes.

As best seen in FIG. 3, an ion generating unit 160 includes a high voltage generator unit 170 and circuitry 180 for converting raw alternating voltage (e.g., 117 VAC) into direct current (“DC”) voltage. Circuitry 180 preferably includes circuitry controlling the shape and/or duty cycle of the generator unit output voltage (which control is altered with user switch S2). Circuitry 180 preferably also includes a pulse mode component, coupled to switch S3, to temporarily provide a burst of increased output ozone. Circuitry 180 can also include a timer circuit and a visual indicator such as a light emitting diode (“LED”). The LED or other indicator (including, if desired, an audible indicator) signals when ion generation quits occurring. The timer can automatically halt generation of ions and/or ozone after some predetermined time, e.g., 30 minutes.

The high voltage generator unit 170 preferably comprises a low voltage oscillator circuit 190 of perhaps 20 KHz frequency, that outputs low voltage pulses to an electronic switch 200, e.g., a thyristor or the like. Switch 200 switchably couples the low voltage pulses to the input winding of a step-up transformer T1. The secondary winding of T1 is coupled to a high voltage multiplier circuit 210 that outputs high voltage pulses. Preferably the circuitry and components comprising high voltage pulse generator 170 and circuit 180 are fabricated on a printed circuit board that is mounted within housing 102.

Output pulses from high voltage generator 170 preferably are at least 10 KV peak-to-peak with an effective DC offset of, for example, half the peak-to-peak voltage, and have a frequency of, for example, 20 KHz. Frequency of oscillation can include other values, but frequency of at least about 20 KHz is preferred as being inaudible to humans. If pets will be in the same room as the unit 100, it may be desired to utilize and even higher operating frequency, to prevent pet discomfort and/or howling by the pet. The pulse train output preferably has a duty cycle of for example 10%, which will promote battery lifetime if live current is not used. Of course, different peak-peak amplitudes, DC offsets, pulse train waveshapes, duty cycle, and/or repetition frequencies can be used instead. Indeed, a 100% pulse train (e.g., an essentially DC high voltage) may be used, albeit with shorter battery lifetime. Thus, generator unit 170 for this embodiment can be referred to as a high voltage pulse generator. Unit 170 functions as a DC:DC high voltage generator, and could be implemented using other circuitry and/or techniques to output high voltage pulses that are input to electrode assembly 220.

As noted, outflow (OUT) may include appropriate amounts of ozone that can remove odors and preferably destroy or at least substantially alter bacteria, germs, and other living (or quasi-living) matter subjected to the outflow. Thus, when switch S1 is closed and the generator 170 has sufficient operating potential, pulses from high voltage pulse generator unit 170 create an outflow (OUT) of ionized air and ozone. When S1 is closed, the LED will visually signal when ionization is occurring.

In practice, unit 100 is placed in a room and connected to an appropriate source of operating potential, typically 117 VAC. With S1 energizing ionization unit 160, systems 100 emits ionized air and preferably some ozone via outlet vents 106. The airflow, coupled with the ions and ozone freshens the air in the room, and the ozone can beneficially destroy or at least diminish the undesired effects of certain odors, bacteria, germs, and the like. The airflow is indeed electro-kinetically produced, in that there are no intentionally moving parts within unit 100. (Some mechanical vibration may occur within the electrodes.)

Foam Emitter Electrodes

Having described various aspects of the invention in general, preferred embodiments of electrode assembly 220 are now described. In the various embodiments, electrode assembly 220 includes a first array 230 of at least one emitter electrode or conductive surface 232, and further includes a second array 240 of preferably at least one collector electrode or conductive surface 242. Understandably material(s) for electrodes 232 and 242 should conduct electricity, be resistant to corrosive effects from the application of high voltage, yet be strong enough to be cleaned.

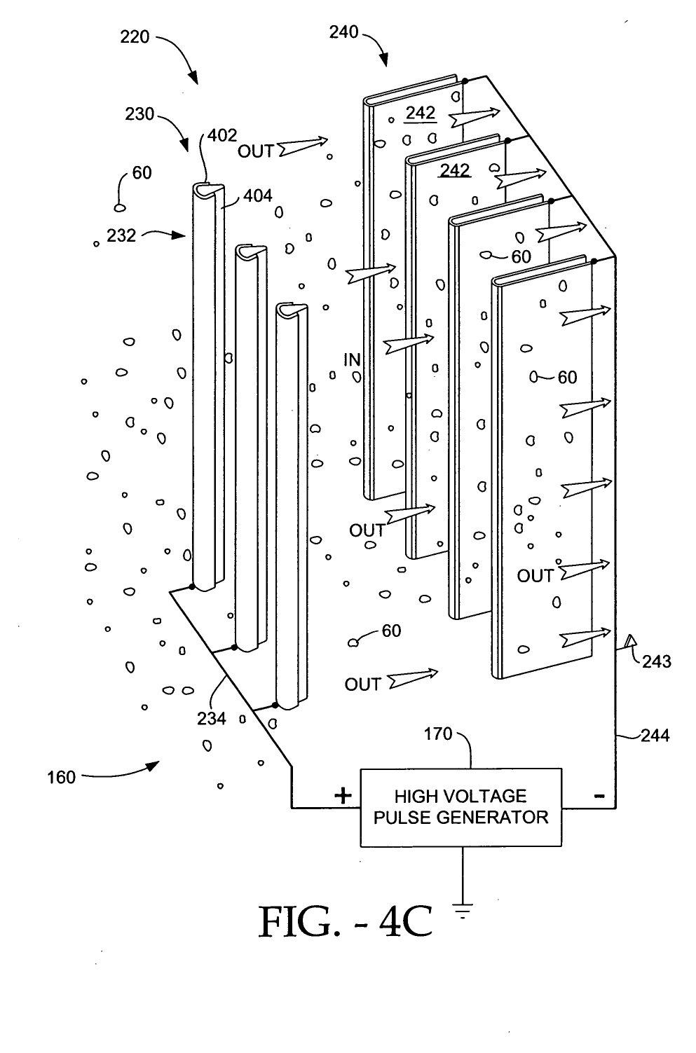

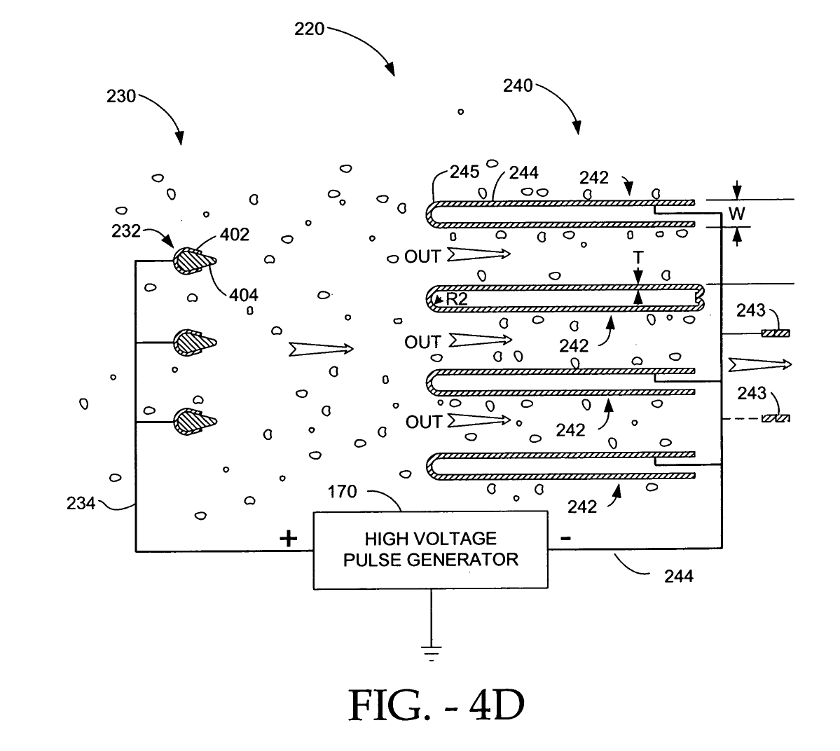

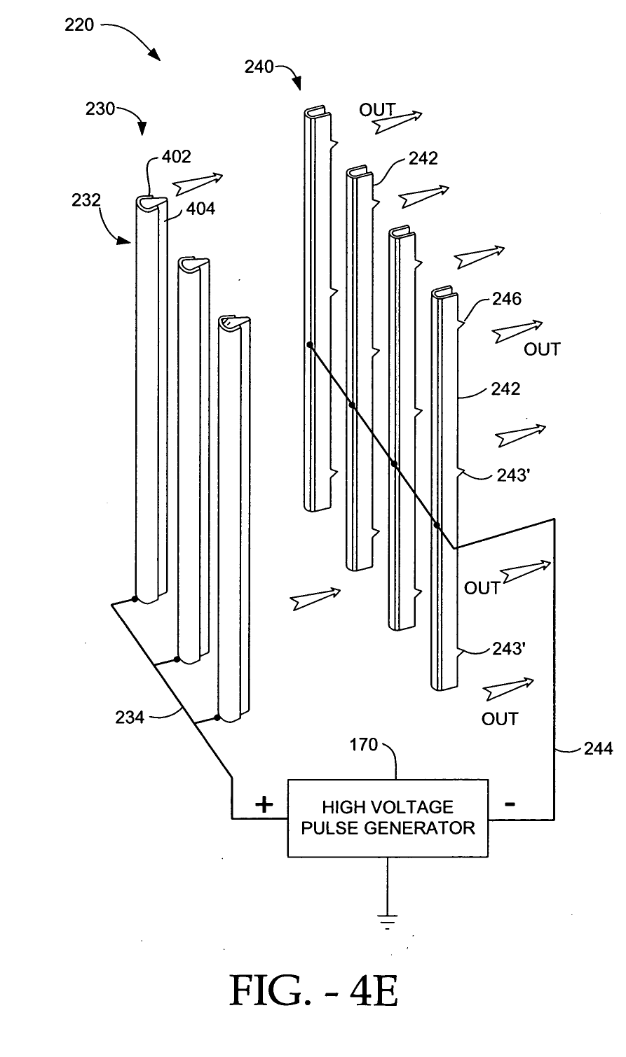

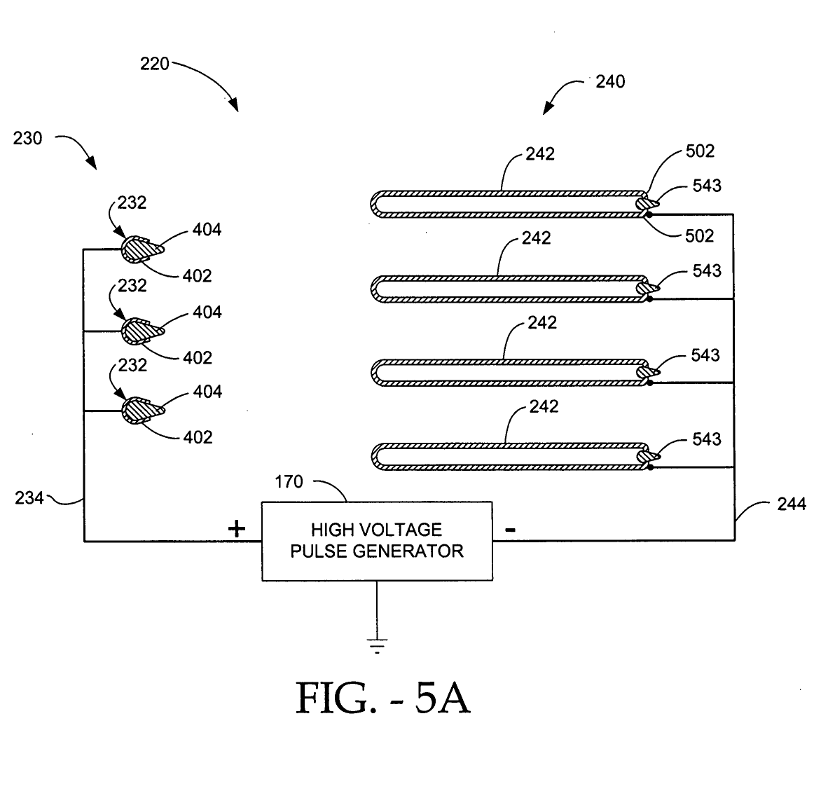

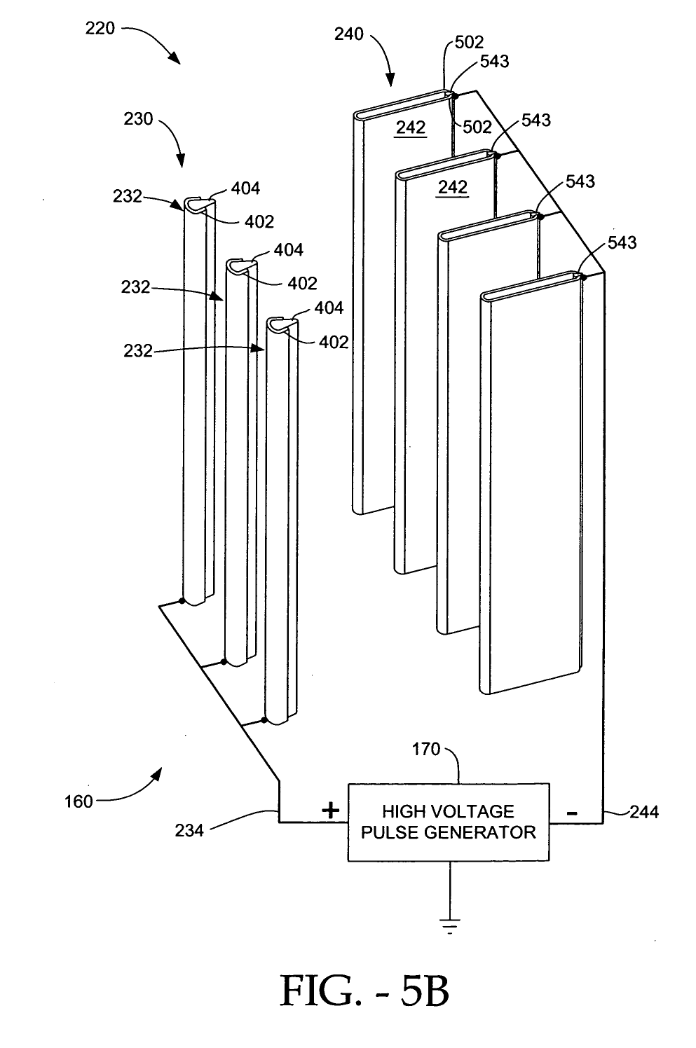

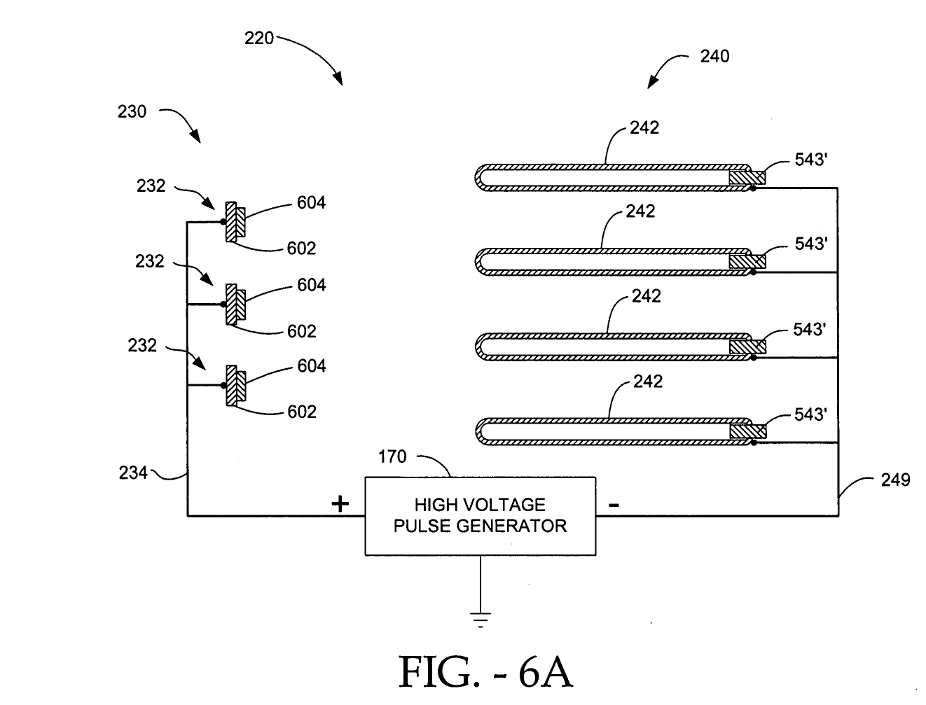

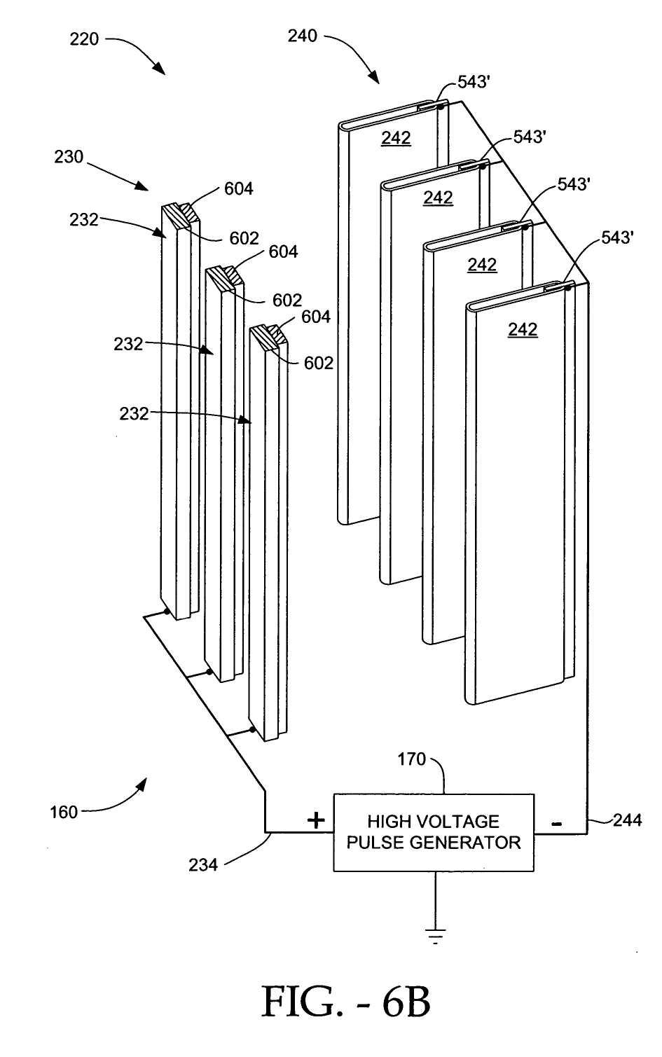

In the various electrode assemblies to be described herein, electrode(s) 232 in the first electrode array 230 preferably include an electrically conductive foam (labeled 404 in FIGS. 4A-5B, and labeled 604 in FIGS. 6A-6B). Use of an electrically conductive foam for electrode(s) 232 promotes higher ionization. This is because the electrically conductive foam has more ion emitting surfaces and points than other designs. According to embodiments of the present invention, such an electrically conductive foam 404 is sufficiently robust to withstand cleaning, has a high melting point to retard breakdown due to ionization, and has a rough exterior surface to promote efficient ionization. For example, such a design can be cleaned under a faucet or in a dishwasher.

In the prior art, emitter or discharge electrodes have generally be made from one or more thin wires, one or more tapered needles, or one or more plates having a sharp or razor like edge, or an edge from which extend pins or a sawtooth like edge. As mentioned above, the thin wires are generally delicate, causing them to be subject to snapping when being cleaned. The alternative types of emitters, such as needless, sawtooth edges or sharp edges, on the other hand, may also be difficult to clean. The use of a conductive foam as the emitter electrode allows for easier cleaning. As will be described below, such a foam can be supported by a support structure, e.g., a metal support structure, that will add strength to the foam emitter electrode. Accordingly, the electrically conductive foam electrode(s) 232 are easier to clean (because they can be removed from the housing by a user) and less likely to be broken than other possible emitter electrodes that may be used in an ion generating electro-kinetic system. The electrically conductive foam electrode(s) 232 should also be safer to clean than emitter electrodes that rely on points or edges for ionization. Various types of foams can be used as the electrically conductive foam 404. In accordance with embodiments of the present invention, the foam is or includes a carbon material and/or is heavily doped with carbon. For example, the electrically conductive foam can be or include a carbon filter material. The electrically conductive foam can be or include an open cell glass carbon foam. In another embodiment, the electrically conductive foam is or includes silicon carbide. In still another embodiment, the electrically conductive foam is or includes a cross-linked polyethylene. According to an embodiment, the electrically conductive foam is or includes a carbon-loaded polyolefin plastic. In a further embodiment, the conductive foam is or includes a metal plated open-cell foam. These are just some types of electrically conductive foams that can be used with embodiments of the present invention. One or ordinary skill in the art will appreciate that other types of electrically conductive foams are also within the spirit and scope of the present invention.

In accordance with an embodiment of the present invention, the electrically conductive foam is or includes an intrinsically conducting polymer (ICP). An ICP has a distinct advantage when used as or in an emitter electrode because the polymer can be doped with varying concentrations of conductive material to act as an internal series resistance component to the emitter array. Such resistivity, and conversely controlled conductivity, act as a current limiting element that helps control corona break-over, and assists with short circuit protection.

By adding electrically conductive fillers in varying concentrations, polymer emitters can be designed with specific properties tailored to each application (e.g., to provide the desired degree of emissivity). For example, electrically conductive fillers can be added to plastics to produce conductive composites. Metal particles (e.g., fibers), including, but not limited to aluminum, steel, iron, copper and nickel coated fiberglass can be used as the conductive fillers. Carbon black and/or carbon fiber may also be used without adverse effect on the thermal conductivity of the material.

In accordance with an embodiment of the present invention, an electrically conductive serrated polymer with a resistivity in the range of about 10 MΩ/cm and a thermal dissipation capability in the range of about 1 watt is used in each of the emitter electrodes. This would provide the desirable current limiting, short circuit protection, and threshold limiting of corona breakover. This may also reduce or eliminate the need for expensive series high voltage resistors that are typically used for short circuit protection and threshold limiting of corona breakover.

FIGS. 4A-4E illustrate various configurations of the electrode assembly 220, according to embodiments of the present invention. The output from high voltage pulse generator unit 170 is coupled to the electrode assembly 220 that includes the first electrode array 230 and the second electrode array 240. As stated above, each array can include a single electrode, or multiple electrodes.

The positive output terminal of unit 170 is coupled to first electrode array 230, and the negative output terminal is coupled to second electrode array 240. It is believed that with this arrangement the net polarity of the emitted ions is positive, e.g., more positive ions than negative ions are emitted. This coupling polarity has been found to work well, including minimizing unwanted audible electrode vibration or hum. However, while generation of positive ions is conducive to a relatively silent airflow, from a health standpoint, it is desired that the output airflow be richer in negative ions, not positive ions. It is noted that in some embodiments, one port (preferably the negative port) of the high voltage pulse generator can in fact be the ambient air. Thus, electrodes in the second array need not be connected to the high voltage pulse generator using a wire. Nonetheless, there will be an “effective connection” between the second array electrodes and one output port of the high voltage pulse generator, in this instance, via ambient air. Alternatively the negative output terminal of unit 170 can be connected to the first electrode array 230 and the positive output terminal can be connected to the second electrode array 240. It is also possible that one of the arrays is grounded, while the other array is connected to a terminal of the high voltage pulse generator 170. For example, the first electrode array 230 may be grounded, while the second array 240 can be connected the negative terminal (or less preferably the positive terminal) of the high voltage generator 170.

With this arrangement an electrostatic flow of air is created, going from the first electrode array 230 towards the second electrode array 240. (This flow is denoted “OUT” in the figures.) Electrode assembly 220 is preferably mounted within transporter system 100 such that second electrode array 240 is closer to the OUT vents 106 and first electrode array 230 is closer to the IN vents 104.

When voltage or pulses from high voltage pulse generator 170 are coupled across first and second electrode arrays 230 and 240, a plasma-like field is created surrounding the emitter electrodes 232 in the first array 230. This electric field ionizes the ambient air between the first and second electrode arrays and establishes an “OUT” airflow that moves towards the second array 240. It is understood that the IN flow enters via vent(s) 104, and that the OUT flow exits via vent(s) 106.

Ozone and ions are generated simultaneously by the first array electrodes 232, essentially as a function of the potential from generator 170 coupled to the first array 230 of electrodes or conductive surfaces. Ozone generation can be increased or decreased by increasing or decreasing the potential at the first array 230. Coupling an opposite polarity potential to the second array electrodes 242 essentially accelerates the motion of ions generated at the first array 230, producing the airflow denoted as “OUT” in the figures. As the ions and ionized particulates move toward the second array 240, the ions and ionized particles push or move air molecules toward the second array 240. The relative velocity of this motion may be increased, by way of example, by decreasing the potential at the second array 240 relative to the potential at the first array 230.

For example, if +10 KV were applied to the first array 230, and no potential were applied to the second array 240, a cloud of ions (whose net charge is positive) would form adjacent the first electrode array 230. Further, the relatively high 10 KV potential would generate substantial ozone. By coupling a relatively negative potential to the second array 240, the velocity of the air mass moved by the net emitted ions increases.

On the other hand, if it were desired to maintain the same effective outflow (OUT) velocity, but to generate less ozone, the exemplary 10 KV potential could be divided between the electrode arrays. For example, generator 170 could provide +4 KV (or some other fraction) to the first array 230 and −6 KV (or some other fraction) to the second array 240. In this example, it is understood that the +4 KV and the −6 KV are measured relative to ground. Understandably it is desired that the unit 100 operates to output appropriate amounts of ozone. Accordingly, the high voltage is preferably fractionalized with about +4 KV applied to the first array 230 and about −6 KV applied to the second array 240. According to an embodiment, there is a 16 KV potential difference between first array 230 and second array 240. For example, generator 170 could provide +8 KV to the first array 230 and −8 KV to the second array 240. These examples are not meant to be limiting.

In the embodiments of FIGS. 4A and 4B, electrode assembly 220 includes a first array 230 including a first electrode 232, and a second array 240 including a pair of collector electrodes 242. First electrode 232 includes a length of electrically conductive foam 404. In the exemplary embodiment shown, the electrically conductive foam 404 is partially surrounded by a generally “U”-shaped support structure 402 that increases the strength of first electrode 232. The support structure can be an electrically conductive material, such as sheet metal. In such an embodiment, the sheet metal is preferably a stainless steel sheet metal, copper, or tungsten, although other metals could be used. The support structure can alternatively be made of some other rigid material, such as plastic or carbon. As shown in the FIG. 4B, a bulbous nose 406 of a U-shaped cross section of support structure 402 faces generally away from the second electrode array 240. In accordance with this embodiment of the present invention, the cross section of the electrically conductive foam 404 has a teardrop shape, with a pointed end of the teardrop shape facing generally toward the second electrode array 240. Exemplary dimensions for the electrically conductive 404 foam include a cross-sectional length of about 10 mm, and a cross-sectional width of about 2 mm (at the widest points). However, other dimensions are within the spirit and scope of the present invention.

If the support structure 402 is electrically conductive, then the support structure 402 can be connected to a terminal of the high voltage generator 170 (to thereby provide the high voltage potential to the electrically conductive foam 404) or to a grounded terminal (in those embodiments where the emitter electrodes 232 are intended to be grounded). If the support structure 402 is not electrically conductive, e.g., because it is made of plastic, then some type of wire or other conductor can provide a conductive path from the electrically conductive foam 404 to a terminal of the high voltage pulse generator 170, or to a grounded terminal.

In embodiment shown, electrodes 242 of the second electrode array 240 are generally “U”-shaped, and formed, for example, from sheet metal, and preferably of stainless steel, although brass or other metals could be used. The sheet metal is readily configured to define side regions 244 and bulbous nose region 246, forming the hollow, elongated “U”-shaped electrodes 242. The electrode(s) 242 in the second electrode array 240 preferably have a highly polished exterior surface to minimize unwanted point-to-point radiation. As such, electrodes 242 are preferably fabricated from stainless steel and/or brass, among other materials. The polished surface of electrodes 242 also promotes ease of electrode cleaning.

For these and the other embodiments, the term “array of electrodes” or “electrode array” may refer to a single electrode or a plurality of electrodes. In the exemplary embodiment shown in FIGS. 4A and 4B, the first array 230 is shown as including a single electrode 232, and the second array 240 is shown as including two electrodes 242. However, the first array 230 can include more than one electrode 232, and the second array 240 can include more than two electrodes 234, as shown in FIGS. 4C and 4D.

While FIGS. 4A and 4B depict two electrodes 242 in the second array 240 and one electrode 232 in first array 230, as noted previously, other numbers of electrodes in each array could be used, preferably retaining a symmetrically staggered configuration as shown. It is seen in FIG. 4A that while particulate matter 60 is present in the incoming (IN) air, the outflow (OUT) air is substantially devoid of particulate matter, which adheres to the preferably large surface area provided by the side regions 244 of the second array electrodes 242. FIG. 4B illustrates that the spaced-apart configuration between the first electrode 232 and second electrodes 242 is staggered. Preferably, each first array electrode 232 is substantially equidistant from two second array electrodes 242. This symmetrical staggering has been found to be an efficient electrode placement.

FIGS. 4C and 4D depicts an embodiment wherein there are three emitter electrodes 232 in the first array 230, and four collector electrodes 242 in the second array 240. In preferred embodiments, the number N1 of emitter electrodes 232 in the first array 230 can preferably differ by one relative to the number N2 of collector electrodes in the second array 240. In many of the embodiments shown, N2>N1. However, if desired, additional first electrodes 232 could be added at the outer ends of array 230 such that N1>N2, e.g., five first electrodes 232 compared to four second electrodes 242.

Note the inclusion in FIGS. 4A-4D of at least one output controlling electrode 243, preferably electrically coupled to the same potential as the second array electrodes 242. Electrode(s) 243 are shown as defining a pointed shape in side profile, e.g., a triangle. The sharp point on electrodes 243 causes generation of substantial negative ions (since the electrode is coupled to relatively negative high potential). These negative ions neutralize excess positive ions otherwise present in the output airflow, such that the OUT flow has a net negative charge. Electrodes 243 is can be stainless steel, copper, or other conductor material, and is perhaps 20 mm high and about 12 mm wide at the base. The inclusion of one electrode 243 has been found sufficient to provide a sufficient number of output negative ions, but more such electrodes may be included.

Additionally, or alternatively, the collector electrode(s) 242 of the second electrode array include electrically conductive foam that will generate substantial negative ions (since the electrode is coupled to relatively negative high potential) to neutralize excess positive ions otherwise present in the output airflow. In such embodiments, the electrically conductive foam can take the place of the output controlling electrode(s) 243. This is discussed in more detail below.

In the embodiments of FIGS. 4A-4D, each “U”-shaped collector electrode 242 has two trailing surface or sides 242 that promote efficient kinetic transport of the outflow of ionized air and ozone. For the embodiment of FIG. 4E, there is the inclusion, on at least one portion of a trailing edge, a pointed electrode region 243′. Electrode region 243′ helps promote output of negative ions, in the same fashion that was previously described with respect to output controlling electrodes 243 shown in FIGS. 4A-4D.

In FIG. 4E and the figures to follow, the particulate matter is omitted for ease of illustration. However, as was shown in FIGS. 4A-4D, particulate matter will be present in the incoming air, and will be substantially absent from the outgoing air. As has been described, particulate matter 60 typically will be electrostatically precipitated upon the surface area of electrodes 242.

An electrode array electrical connection can be made in number of locations. Thus, emitter electrodes 232 are shown electrically connected together at their bottom regions by conductor 234, whereas collector electrodes 242 are shown electrically connected together in their middle regions by the conductor 244. However, arrays may be connected together in more than one region, e.g., at the top and at the bottom. It is preferred that the wire of strips or other inter-connecting mechanisms be at the top, bottom, or periphery of the second array electrodes 242, so as to minimize obstructing stream air movement through the housing 102.

In the above described embodiments output controlling electrodes 243 and 243′ were shown as being pointed. Accordingly, such pointed electrodes may be sharp, requiring care to be taken when cleaning them, especially for the electrodes 243′ shown in FIG. 4E. Further, if a sheet of cloth or the like is used to clean off the electrodes, it is possible that the sheet will get caught on the pointed electrodes 243 or 243′.

In accordance with embodiments of the present invention, the sharp or pointy output controlling electrodes 243 and 243′ are replaced with electrically conductive foam controlling electrodes, which can be made of the same materials as the electrically conductive emitter electrodes discussed above. For example, referring back to FIG. 4A-4E, the sharp metal controlling electrodes 243 can be replaced with similarly shaped foam electrodes. However, since the foam will have many emitting surfaces regardless of shape, the foam controlling electrodes need only be placed downstream or near the rear portion of the collector electrodes to perform the intended function of neutralizing excess positive ions that otherwise may be present in the output airflow. For example, the foam controlling electrode can be a block or strip of foam. Preferably, however, the foam is fitted into the rear portion of the second electrodes 242, as will be explained with reference to FIGS. 5A and 5B.

Referring now to FIGS. 5A and 5B, a strip of foam 543 is placed between the downstream ends 502 of each of the second electrodes 242. As shown, the downstream ends 502 are curved inward to crimp the strip of foam 543, to thereby keep it in place. In accordance with an embodiment of the present invention, the strip of foam 543 has a teardrop shape similar to the shape of the foam 404 of the emitters 232. However, the strip of foam 404 can have other shapes, such as oval or rectangular, and may fit deeper into the hollow portion of the collector electrodes 242, and/or extend further beyond the distal ends 502 of the collector electrodes 232, than shown in FIGS. 5A and 5B.

In FIGS. 4A-5B the foam portions 404 of the emitter electrodes 232 were shown and described as having a teardrop like shape. Further, in FIGS. 4A-5B, the support structure 402 for the emitter electrodes were shown and described as being generally U-shaped. However, the conductive foam 404 and support structure 402 can have other shapes. For example, referring to FIG. 6A, each emitter electrode 232 includes a strip or elongated plate of supporting material 602, which is likely a metal, but can be carbon or plastic or some other material. In this embodiment, a similarly shaped strip of electrically conductive carbon foam 604 is attached to the supporting structure 602, e.g., by an adhesive or the like. Other shapes for the supporting structure 602 and electrically conductive foam 604 of an emitting electrode 232 are within the spirit and scope of the present invention.

As also shown in FIGS. 6A and 6B, the electrically conductive collector foam 543 extending from the rear portion of collector electrodes 242 is replaced with foam 543′ of a rectangular shape. Foam of other shapes are also within the scope of the present invention

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Modifications and variations may be made to the disclosed embodiments without departing from the subject and spirit of the invention as defined by the following claims. For example, many of the embodiments disclosed herein can be combined with the embodiments described in U.S. Pat. No. 6,176,977 or U.S. patent application Ser. No. 10/074,827, which were incorporated herein by reference above. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

1. An electro-kinetic air transporter and conditioner system, comprising:
a first electrode array including at least one emitter electrode;
a second electrode array including at least one collector electrode; and
a voltage generator to provide a potential difference between said first electrode array and said second electrode array;
wherein said first electrode array comprises electrically conductive foam.

2. The system of claim 1, wherein said electrically conductive foam is made of a carbon filter material.

3. The system of claim 2, wherein at least one emitter electrode in said first electrode array comprises a metal structure having a generally U-shaped cross section, and wherein at least a portion of said electrically conductive foam occupies an interior of the generally U-shaped cross section.

4. The system of claim 3, wherein a bulbous nose of said U-shaped cross section faces generally away from said second electrode array.

5. The system of claim 4, wherein a cross section of said electrically conductive foam has a teardrop shape, with a pointed end of the teardrop shape facing generally toward said second electrode array.

6. The system of claim 5, wherein the electrically conductive foam has a cross-sectional length of about 10 mm, and a cross-sectional width of about 2 mm.

7. The system of claim 1, wherein said system is incorporated in an elongated freestanding housing with a top, wherein each of said first electrode array and said second electrode array are elongated and removable through said top of said housing.

8. The system of claim 7, further comprising:
a handle affixed to said first electrode array and said second electrode array to assist in removal of said first electrode array and said second electrode array from said housing.

9. The system of claim 7, further comprising:
a first handle affixed to said first electrode array to assist in removal of said first electrode array from said housing.
a second handle affixed to said second electrode array to assist in removal of said second electrode array from said housing.

10. The system of claim 1, wherein said system is incorporated in an elongated freestanding housing with a top, wherein each of said first electrode array and said second electrode array are elongated and at least partially removable through said top of said housing.

11. The system of claim 1, wherein the electrically conductive foam comprises carbon foam.

12. The system of claim 1, wherein the electrically conductive foam comprises open cell glass carbon foam.

13. The system of claim 1, wherein the electrically conductive foam comprises silicon carbide.

14. The system of claim 1, wherein the electrically conductive foam comprises cross-linked polyethylene.

15. The system of claim 1, wherein the electrically conductive foam comprises carbon-loaded polyolefin plastic.

16. The system of claim 1, wherein the electrically conductive foam comprises a metal plated open-cell foam.

17. The system of claim 1, wherein the electrically conductive foam comprises an intrinsically conducting polymer.

18. The system of claim 1, wherein the electrically conductive foam comprises an electrically conductive serrated polymer.

19. The system of claim 19, wherein each emitter electrode has a resistivity in the range of about 10MΩ/cm and a thermal dissipation capability in the range of about 1 watt.

20. The system of claim 1, wherein said at least one emitter electrode in said first electrode array comprises an elongated support structure, and wherein at least a portion of said electrically conductive foam is attached to said support structure.

21. The system of claim 1, wherein said electrically conductive foam comprises a strip of foam that is attached along an elongated length of said elongated support structure.

22. The system of claim 1, wherein at least one said collector electrode is generally U-shaped with a bulbous nose facing and two sides extending in a downstream direction away from said first array.

23. The system of claim 22, further comprising further electrically conductive foam extending from a gap between downstream ends of said two sides of said generally U-shaped collector electrode of said second array.

24. The system of claim 23, wherein said further electrically conductive foam is crimped between said two sides of said generally U-shaped collector electrode.

25. An electro-kinetic air transporter and conditioner system, comprising:
a first array including at least one emitter electrode;
a second array including at least one collector electrode; and
a voltage generator to provide a potential difference between said first array and said second array;
wherein said first electrode array comprises electrically conductive foam that generally faces said second array.

26. The system of claim 25, wherein said second array is connected to a negative terminal of said voltage generator.

27. The system of claim 26, wherein said emitter electrode is connected to a positive terminal of said voltage generator.

28. The system of claim 26, wherein said emitter electrode is connected to ground.

29. An electro-kinetic air conditioner system, comprising:
a first array including at least one emitter electrode;
a second array including at least one generally U-shaped collector electrode with a bulbous nose facing said first array and two sides extending in a downstream direction away from said first array;
an electrically conductive foam crimped between said two sides of said generally U-shaped collector electrode; and
a high voltage generator;
wherein said second array and said electrically conductive foam receive a negative voltage potential from said high voltage generator.

30. The system of claim 29, wherein said first array receives a positive voltage potential from said high voltage generator.

31. The system of claim 29, wherein said first array is grounded.

32. An electro-kinetic air transporter and conditioner system, comprising:
a first array including at least one emitter electrode;
a second array including at least one collector electrode; and
a voltage generator to provide a potential difference between said first array and said second array;
wherein said first electrode array comprises electrically conductive foam that generally faces said second array; and
wherein said second electrode array comprises further electrically conductive foam that generally faces away from said first array.

33. An electro-kinetic air transporter and conditioner system, comprising:
a first array including two emitter electrodes;
a second array including three collector electrodes; and
a voltage generator to provide a potential difference between said first array and said second array;
wherein each electrode in said first electrode array comprises electrically conductive foam that generally faces said second array; and
wherein each electrode in said second electrode array comprises further electrically conductive foam that generally faces away from said first array.

34. An electro-kinetic air conditioner system, comprising:
a first array including at least one emitter electrode;
a second array including at least one collector electrode that includes an electrically conductive foam portion; and
a high voltage generator that provides a negative voltage potential to said second array.

35. An electro-kinetic air transporter and conditioner system, comprising:
a first electrode array including at least one emitter electrode;
a second electrode array including at least one collector electrode; and
a voltage generator to provide a potential difference between said first electrode array and said second electrode array;
wherein said first electrode array comprises electrically conductive foam.
